(19) United States
(12) Patent Application Publication
(10) Pub. No.: US 2010/0065408 A1
(43) Pub. Date: Mar. 18, 2010

(54) INPUT APPARATUS

(76) Inventors: CHIH-HSIANG CHIANG, Zhongli City (TW); CHIH-CHUNG YEN, Bade City (TW)

Correspondence Address: PATTERSON & SHERIDAN, LLP - - - IPTEC, 3040 Post Oak Boulevard, Suite 1500, Houston, TX, 77056-6582, US

(21) Appl. No.: 12/558,655

(22) Filed: Sep. 14, 2009

(30) Foreign Application Priority Data
Sep. 17, 2008 (TW) 097216798

(51) Int. Cl. H01H 9/00

(52) U.S. Cl. 200/314

(57) ABSTRACT

The invention provides an input apparatus. The input apparatus comprises a base plate, at least one keyswitch, a light guiding module, and a lighting module. The light guiding module is set under the base plate. The lighting module is set under the light guiding module within the range the base plate covers. The lighting module comprises a circuit board and a plurality of lighting units. The plurality of lighting units are coupled to the circuit board and aligned interlacedly according to different lighting directions of them.

### BACKGROUND OF THE INVENTION

1. Field of the Invention

The invention relates to an input apparatus, and more particularly, to an input apparatus including lighting units arranged on a soft circuit board in different ways.

2. Description of the Prior Art

With the developing of the technology, the information equipment has also become popular. Taking the most-used computer for example, there are various kinds of computers on the market, and they are used in every place, such as a home, a factory, an office, and a school, and almost become a necessary apparatus in our daily life. A well-known computer, no matter a desktop computer or a notebook, needs a keyboard for a user to input words.

At present, there is a kind of lighting keyboard shown on the market. Since the lighting keyboard has the lighting function that the conventional keyboard lacks of, therefore, the lighting keyboard can widely attract the attentions of the consumers and become popular. Please refer to FIG. 1. FIG. 1 shows an appearance view of an ordinary lighting keyboard. As shown in FIG. 1, the lighting keyboard 1 includes a base plate 14 and a plurality of keyswitches 16 set on the base plate 14.

Then, please refer to FIG. 2. FIG. 2 shows a soft circuit board and lighting units of the lighting keyboard 1 shown in FIG. 1. As shown in FIG. 2, the soft circuit board 10 is set in the range that the base plate 14 covers and located on the horizontal side. The plurality of lighting units 12 is set on the soft circuit board 10 and used to emit lights for the lighting keyboard 1.

However, if the actual production cost of the lighting keyboard 1 is taken into consideration, in the current configuration way for the soft circuit board 10 and the lighting units 12 of the lighting keyboard 1, the soft circuit board 10 is set on the longer horizontal side of the lighting keyboard 1, therefore, the area of the soft circuit board 10 needed in the lighting keyboard 1 will become larger in this configuration way. Additionally, since the soft circuit board 10 is not set on the center of the lighting keyboard 1, the number of the lighting units 12 needed in the lighting keyboard 1 will be increased, therefore, the production cost of the lighting keyboard 1 will be also increased, and the competitiveness of the lighting keyboard 1 on the market will be affected accordingly.

Therefore, the invention provides an input apparatus including lighting units arranged on a soft circuit board in different ways to solve the above-mentioned problems.

### SUMMARY OF THE INVENTION

The invention provides an input apparatus. In fact, the input apparatus can be a lighting keyboard. The invention can reduce the production cost of the input apparatus and increase its competitiveness on the market by changing the arranging way of the lighting units of the input apparatus on the soft circuit board.

A first embodiment of the invention is an input apparatus. The input apparatus includes a base plate, at least one keyswitch, a light guiding module, and a lighting module. The at least one keyswitch is set on the base plate. The light guiding module is set under the base plate. The lighting module is set under the light guiding module within the range the base plate covers. In fact, the lighting module is set on the center of the range of the base plate and parallel to the straight sides of the base plate. The lighting module includes a circuit board and a plurality of lighting units. The plurality of lighting units is coupled to the circuit board and aligned interlacedly according to different lighting directions of the plurality of lighting units.

In this embodiment, the circuit board is a flexible printed circuit (FPC) and the plurality of lighting units is light emitting diode (LED). In fact, the plurality of lighting units can be aligned in a linear way or a nonlinear way.

A second embodiment of the invention is an input apparatus. The input apparatus includes a base plate, at least one keyswitch, a light guiding module, and a lighting module. The at least one keyswitch is set on the base plate. The light guiding module is set under the base plate. The lighting module is set under the light guiding module within the range the base plate covers. In fact, the lighting module is set on the center of the range of the base plate and parallel to the straight sides of the base plate. The lighting module includes a circuit board and a plurality of lighting units. The plurality of lighting units is coupled to the circuit board.

In this embodiment, the plurality of lighting units can be divided into a first set of lighting units and a second set of lighting units. The first set of lighting units is aligned on a first side of the circuit board and emits light toward a first direction; the second set of lighting units is aligned on a second side of the circuit board and emits light toward a second direction.

In fact, the first direction corresponds to the first side of the circuit board and the second direction corresponds to the second side of the circuit board. The circuit board is a flexible printed circuit and the plurality of lighting units is light emitting diode.

A third embodiment of the invention is an input apparatus. The input apparatus includes a base plate, at least one keyswitch, a light guiding module, and a lighting module. The at least one keyswitch is set on the base plate. The light guiding module is set under the base plate. The lighting module is set under the light guiding module within the range the base plate covers. In fact, the lighting module is set on the center of the range of the base plate and parallel to the straight sides of the base plate. The lighting module includes a circuit board and a plurality of lighting units. The plurality of lighting units is coupled to the circuit board.

In this embodiment, the plurality of lighting units is arranged in a ring form and emits light toward the outside of the ring form. In fact, the circuit board is a flexible printed circuit and the plurality of lighting units is light emitting diode.

Compared to the prior arts, in the input apparatus provided by the invention, since its soft circuit board is set on the center of the range of the substrate and parallel to the shorter straight sides of the substrate, therefore, the area of the soft circuit board needed in the input apparatus of the invention can be smaller than that of the soft circuit board in conventional lighting keyboard. With that, the invention can effectively reduce the production cost of the lighting keyboard and increase its competitiveness on the market.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 shows an appearance view of an ordinary lighting keyboard.

FIG. 2 shows a soft circuit board and lighting units of the lighting keyboard shown in FIG. 1.

FIG. 3 shows an appearance view of a lighting keyboard according to the first embodiment of the invention.

FIG. 4 shows a cross-sectional view of the lighting keyboard shown in FIG. 3 formed along the line A.

FIG. 5 shows the positions of the soft circuit board and the lighting units of the lighting keyboard shown in FIG. 4.

FIG. 6 shows the positions of the soft circuit board and the lighting units of the lighting keyboard different from that of FIG. 5.

FIG. 7 shows an appearance view of a lighting keyboard according to the second embodiment of the invention.

FIG. 8 shows a cross-sectional view of the lighting keyboard shown in FIG. 7 formed along the line B.

FIG. 9 shows the positions of the soft circuit board and the lighting units of the lighting keyboard shown in FIG. 8.

FIG. 10 shows an appearance view of a lighting keyboard according to the third embodiment of the invention.

FIG. 11 shows a cross-sectional view of the lighting keyboard shown in FIG. 10 formed along the line C.

FIG. 12 shows the positions of the soft circuit board and the lighting units of the lighting keyboard shown in FIG. 11.

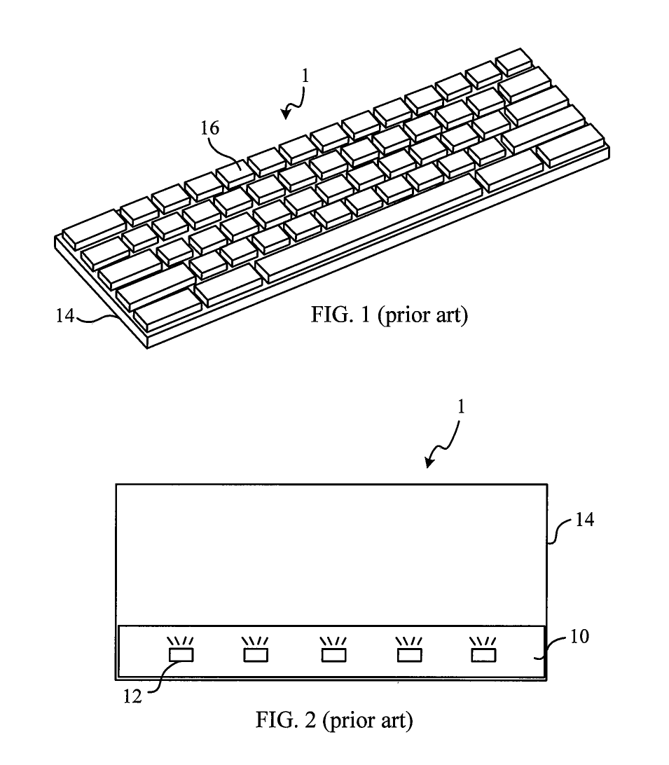

### DETAILED DESCRIPTION OF THE INVENTION

The invention provides an input apparatus. In fact, the input apparatus can be a lighting keyboard used to operate a desktop computer, a notebook, or other electronic equipments. The invention can reduce the production cost of the input apparatus and increase its competitiveness on the market by changing the arranging way of the lighting units of the input apparatus on the soft circuit board.

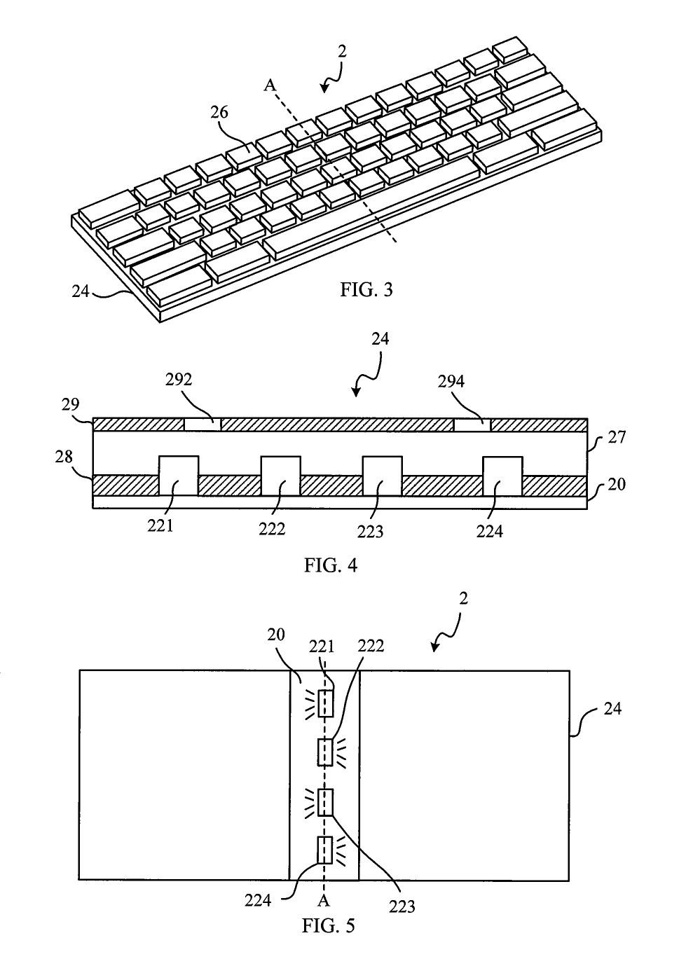

A first embodiment of the invention is a lighting keyboard. In fact, the lighting keyboard can be used to operate a desktop computer, a notebook, or other electronic equipments. Please refer to FIG. 3. FIG. 3 shows an appearance view of the lighting keyboard. As shown in FIG. 3, the lighting keyboard 2 includes a base plate 24 and a plurality of keyswitches 26.

Next, please refer to FIG. 4. FIG. 4 shows a cross-sectional view of the lighting keyboard 2 shown in FIG. 3 formed along the line A. As shown in FIG. 4, a soft circuit board 20, lighting units 221˜224, a light guiding plate 27, a reflective layer 28, and a shielding layer 29 are set in the base plate 24 of the lighting keyboard 2, wherein the reflective layer 28 and the shielding layer 29 are set under and above the light guiding plate 27 respectively. In fact, the lighting units 221˜224 can be light emitting diode devices or other lighting devices.

As shown in FIG. 4, the lighting units 221˜224 are set and coupled onto the soft circuit board 20, and the lighting units 221˜224 will penetrate the reflective layer 28 and extend into the light guiding plate 27. When the lighting units 221˜224 emit lights in the light guiding plate 27, the light guiding plate 27 will conduct the lights, so that the lights can be transmitted in the light guiding plate 27.

Since the reflective layer 28 and the shielding layer 29 are both opaque, therefore, the lights in the light guiding plate 27 can be emitted out of the light guiding plate 27 only from a first transparent area 292 and a second transparent area 294 on the shielding layer 29 into the keyswitch 26 set above the base plate 24. When the lights are emitted out from the transparent keycap of the keyswitch 26, the lighting effect of the lighting keyboard 2 can be achieved.

Please refer to FIG. 5. FIG. 5 shows the positions of the soft circuit board 20 and the lighting units 221˜224 of the lighting keyboard 2 shown in FIG. 4. As shown in FIG. 5, the soft circuit board 20 is set within the range the base plate 24 covers. It should be noticed that the soft circuit board 20 is located on the center of the range of the base plate 24 and parallel to the straight side of the base plate 24 in this embodiment.

In this embodiment, the lighting units 221˜224 are set upon the soft circuit board 20 and coupled to the soft circuit board 20. As shown in FIG. 5, the lighting units 221˜224 are aligned interlacedly according to different lighting directions of the lighting units 221˜224. That is to say, it is assumed that the lighting units 221˜224 are aligned top-down in order, if the first lighting unit 221 emits light to the left direction, then the second lighting unit 222 will light to the right direction, the third lighting unit 223 will light to the left direction, and the fourth lighting unit 224 will light to the right direction.

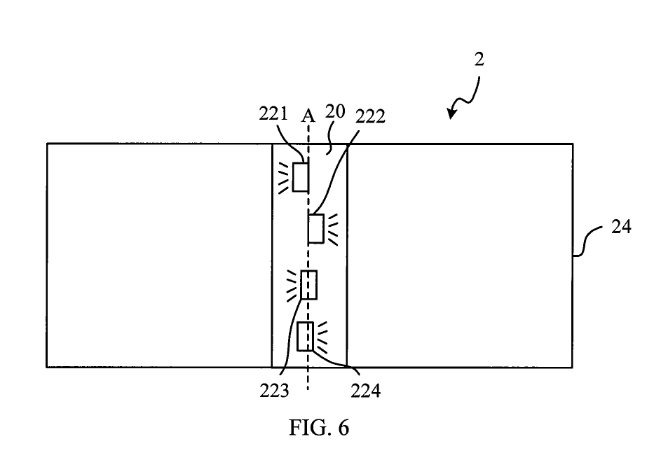

In practical applications, the interlacedly aligned lighting units 221˜224 can be aligned not only in a linear way, but also in a nonlinear way. Comparing FIG. 5 and FIG. 6, it can be found that the lighting units 221˜224 shown in FIG. 5 are neatly aligned on the line A, but the lighting units 221˜224 shown in FIG. 6 are aligned in a nonlinear way, wherein the position of the lighting unit 221 slightly deviates from the line A to the left side, and the position of the lighting unit 222 slightly deviates from the line A to the right side. In fact, the arranging way of the lighting units 221˜224 can have other possibilities; it is not limited to this case.

Above all, compared to the conventional lighting keyboard 1 shown in FIG. 2, since the soft circuit board 20 of the lighting keyboard 2 shown in FIG. 5 is set on the center of the range covered by the base plane 24 and parallel to the shorter straight side of the base plane 24, therefore, the area of the soft circuit board 20 needed in the lighting keyboard 2 will be smaller than that of the conventional lighting keyboard 1, and the number of the lighting units needed in the lighting keyboard 2 will be also smaller than that of the conventional lighting keyboard 1. With that, the production cost of the lighting keyboard 2 in the invention can be lower than that of the conventional lighting keyboard 1.

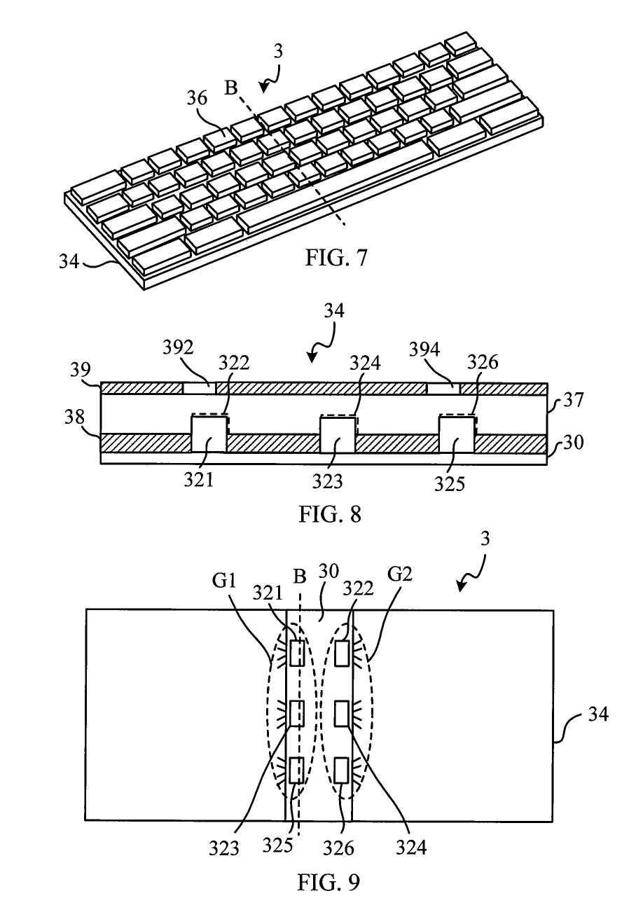

A second embodiment of the invention is a lighting keyboard. In fact, the lighting keyboard can be used to operate a desktop computer, a notebook, or other electronic equipments. Please refer to FIG. 7. FIG. 7 shows an appearance view of the lighting keyboard. As shown in FIG. 7, the lighting keyboard 3 includes a base plate 34 and a plurality of keyswitches 36.

Next, please refer to FIG. 8. FIG. 8 shows a cross-sectional view of the lighting keyboard 3 shown in FIG. 7 formed along the line B. As shown in FIG. 8, a soft circuit board 30, lighting units 321˜326, a light guiding plate 37, a reflective layer 38, and a shielding layer 39 are set in the base plate 34 of the lighting keyboard 3, wherein the reflective layer 38 and the shielding layer 39 are set under and above the light guiding plate 37 respectively. In fact, the lighting units 321˜326 can be light emitting diode devices or other lighting devices.

As shown in FIG. 8, the lighting units 321˜326 are set and coupled onto the soft circuit board 30, and the lighting units 321˜326 will penetrate the reflective layer 38 and extend into the light guiding plate 37. When the lighting units 321˜326 emit lights in the light guiding plate 37, the light guiding plate 37 will conduct the lights, so that the lights can be transmitted in the light guiding plate 37.

Since the reflective layer 38 and the shielding layer 39 are both opaque, therefore, the lights in the light guiding plate 37 can be emitted out of the light guiding plate 37 only from a first transparent area 392 and a second transparent area 394 on the shielding layer 39 into the keyswitch 36 set above the base plate 34. When the lights are emitted out from the transparent keycap of the keyswitch 36, the lighting effect of the lighting keyboard 3 can be achieved.

Please refer to FIG. 9. FIG. 9 shows the positions of the soft circuit board 30 and the lighting units 321˜326 of the lighting keyboard 3 shown in FIG. 8. As shown in FIG. 9, the soft circuit board 30 is set within the range the base plate 34 covers. It should be noticed that the soft circuit board 30 is located on the center of the range of the base plate 34 and parallel to the shorter straight side of the base plate 34.

In this embodiment, the lighting units 321˜326 are set upon the soft circuit board 30 and coupled to the soft circuit board 30. As shown in FIG. 9, the lighting units 321˜326 can be divided into two sets of lighting units including a first set of lighting units G1 and a second set of lighting units G2. The first set of lighting units G1 includes the lighting units 321, 323, and 325; the second set of lighting units G2 includes the lighting units 322, 324, and 326.

As shown in FIG. 9, the first set of lighting units G1 is arranged on the left side of the soft circuit board 30 and emits lights toward the left direction; the second set of lighting units G2 is arranged on the right side of the soft circuit board 30 and emits lights toward the right direction.

In fact, it has no limitation to the number of the lighting units that each set of lighting units has. That is to say, the number of the lighting units that the first set of lighting units G1 has can be different from that of the lighting units that the second set of lighting units G2 has. In addition, the lighting direction of the lighting units of the first set of lighting units G1 and that of the second set of lighting units G2 can be also different. And, he lighting direction of the lighting units of the first set of lighting units G1 can even opposite to that of the lighting units of the second set of lighting units G2, but not limited to this case.

In this embodiment, the purpose of using the above-mentioned arranging way is that the first set of lighting units G1 and the second set of lighting units G2 located on the central area of the lighting keyboard 3 can provide enough light sources to the left-side area and the right-side area of the lighting keyboard 3 respectively.

In practical applications, the lighting units of the first set of lighting units G1 or the second set of lighting units G2 can be aligned not only in a linear way, but also in a nonlinear way. In fact, the arranging way of the lighting units of the first set of lighting units G1 or the second set of lighting units G2 can still have other possibilities; it is not limited to this case.

Above all, compared to the conventional lighting keyboard 1 shown in FIG. 2, since the soft circuit board 30 of the lighting keyboard 3 shown in FIG. 9 is set on the center of the range covered by the base plane 34 and parallel to the shorter straight side of the base plane 34, therefore, the area of the soft circuit board 30 needed in the lighting keyboard 3 will be smaller than that of the conventional lighting keyboard 1, so that the production cost of the lighting keyboard 3 in the invention can be lower than that of the conventional lighting keyboard 1.

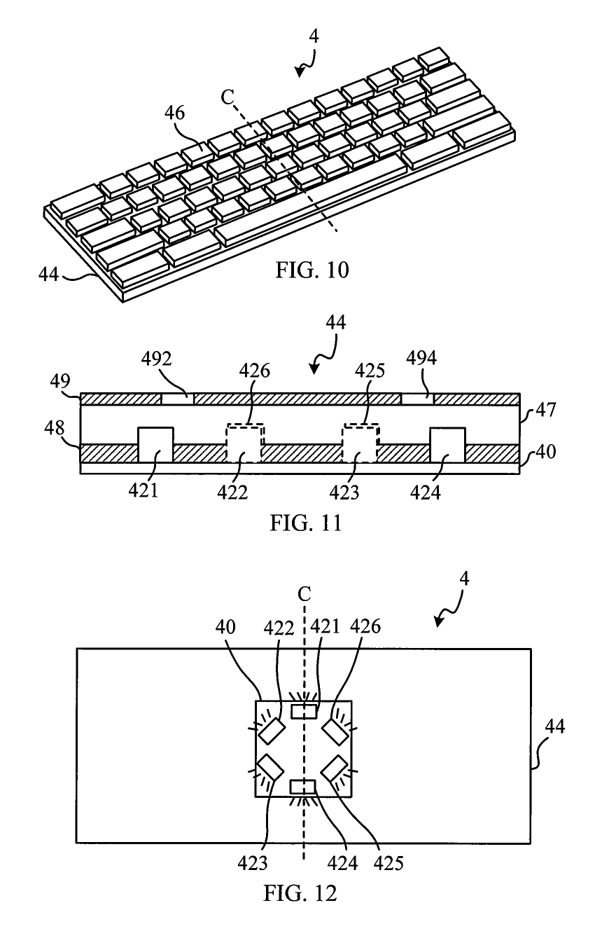

A third embodiment of the invention is a lighting keyboard. In fact, the lighting keyboard can be used to operate a desktop computer, a notebook, or other electronic equipments. Please refer to FIG. 10. FIG. 10 shows an appearance view of a lighting keyboard. As shown in FIG. 10, the lighting keyboard 4 includes a base plate 44 and a plurality of keyswitches 46.

Next, please refer to FIG. 11. FIG. 11 shows a cross-sectional view of the lighting keyboard 4 shown in FIG. 10 formed along the line C. As shown in FIG. 11, a soft circuit board 40, lighting units 421˜426, a light guiding plate 47, a reflective layer 48, and a shielding layer 49 are set in the base plate 44 of the lighting keyboard 4, wherein the reflective layer 48 and the shielding layer 49 are set under and above the light guiding plate 47 respectively. In fact, the lighting units 421˜426 can be light emitting diode devices or other lighting devices.

As shown in FIG. 11, the lighting units 421˜426 are set and coupled onto the soft circuit board 40, and the lighting units 421˜426 will penetrate the reflective layer 48 and extend into the light guiding plate 47. When the lighting units 421˜426 emit lights in the light guiding plate 47, the light guiding plate 47 will conduct the lights, so that the lights can be transmitted in the light guiding plate 47.

Since the reflective layer 48 and the shielding layer 49 are both opaque, therefore, the lights in the light guiding plate 47 can be emitted out of the light guiding plate 47 only from a first transparent area 492 and a second transparent area 494 on the shielding layer 49 into the keyswitch 46 set above the base plate 44. When the lights are emitted out from the transparent keycap of the keyswitch 46, the lighting effect of the lighting keyboard 4 can be achieved.

Please refer to FIG. 12. FIG. 12 shows the positions of the soft circuit board 40 and the lighting units 421˜426 of the lighting keyboard 4 shown in FIG. 11. As shown in FIG. 12, the soft circuit board 40 is set within the range the base plate 44 covers. It should be noticed that the soft circuit board 40 is located on the center of the range of the base plate 44 and parallel to the shorter straight side of the base plate 44.

In this embodiment, the lighting units 421˜426 are set upon the soft circuit board 40 and coupled to the soft circuit board 40. As shown in FIG. 12, the lighting units 421˜426 are arranged in a ring form on the soft circuit board 40. Since the soft circuit board 40 is located on the central area of the lighting keyboard 4, therefore, each of the lighting units 421˜426 can emit light toward the outside of the ring form, so that other areas of the lighting keyboard 4 can also receive the lights provided by the lighting units 421˜426.

In fact, the number of the lighting units forming the ring form has no limitations, not limited to this case. Moreover, the purpose of arranging the lighting units 421˜426 in the ring form shown as FIG. 12 is to uniformly transmit the lights emitted from the lighting units 421˜426 to each area of the lighting keyboard 4. In practical applications, it is not necessary to arrange the lighting units 421˜426 in the symmetrical ring form.

Above all, compared to the conventional lighting keyboard 1 shown in FIG. 2, since the soft circuit board 40 of the lighting keyboard 4 shown in FIG. 12 is set on the center of the range covered by the base plane 44 and parallel to the shorter straight side of the base plane 44, therefore, the area of the soft circuit board 40 needed in the lighting keyboard 4 will be smaller than that of the conventional lighting keyboard 1, so that the production cost of the lighting keyboard 4 in the invention can be lower than that of the conventional lighting keyboard 1.

Compared to the prior arts, in the input apparatus provided by the invention, since its soft circuit board is set on the center of the range of the substrate and parallel to the shorter straight sides of the substrate, therefore, the area of the soft circuit board needed in the input apparatus of the invention can be smaller than that of the soft circuit board in conventional lighting keyboard. With that, the invention can effectively reduce the production cost of the lighting keyboard and increase its competitiveness on the market.

Although the present invention has been illustrated and described with reference to the preferred embodiment thereof, it should be understood that it is in no way limited to the details of such embodiment but is capable of numerous modifications within the scope of the appended claims.

What is claimed is:

1. An input apparatus, comprising:
a base plate;
at least one keyswitch, set on the base plate;
a light guiding module, set under the base plate; and
a lighting module, set under the light guiding module within the range the base plate covers, the lighting module comprising:
a circuit board; and
a plurality of lighting units, coupled to the circuit board and aligned interlacedly according to different lighting directions of the plurality of lighting units.

2. The input apparatus of claim 1, being a lighting keyboard.

3. The input apparatus of claim 1, wherein the circuit board is a soft circuit board.

4. The input apparatus of claim 1, wherein the plurality of lighting units are light emitting diode (LED) devices.

5. The input apparatus of claim 1, wherein the plurality of lighting units is aligned in a linear way.

6. The input apparatus of claim 1, wherein the plurality of lighting units is aligned in a nonlinear way.

7. The input apparatus of claim 1, wherein the light guiding module comprises:
a light guiding plate;
a reflective layer which is light-proof and set under the light guiding plate; and
a shielding layer, set above the light guiding plate and having a light-proof area and a transparent area;
wherein the plurality of lighting units penetrate the reflective layer and extend into the light guiding plate, the light guiding plate is used for transmitting a light emitted by the plurality of lighting units, the reflective layer is used for reflecting the light, and the shielding layer is used for limiting the light to be emitted out from the transparent area only.

8. An input apparatus, comprising:
a base plate;
at least one keyswitch, set on the base plate;
a light guiding module, set under the base plate; and
a lighting module, set under the light guiding module within the range the base plate covers, the lighting module comprising:
a circuit board; and
a plurality of lighting units, coupled to the circuit board, the plurality of lighting units comprising a first set of lighting units and a second set of lighting units, the first set of lighting units being aligned on a first side of the circuit board and lighting toward a first direction, the second set of lighting units being aligned on a second side of the circuit board and lighting toward a second direction.

9. The input apparatus of claim 8, being a lighting keyboard.

10. The input apparatus of claim 8, wherein the circuit board is a soft circuit board.

11. The input apparatus of claim 8, wherein the plurality of lighting units are light emitting diode (LED) devices.

12. The input apparatus of claim 8, wherein the first direction corresponds to the first side of the circuit board and the second direction corresponds to the second side of the circuit board.

13. The input apparatus of claim 8, wherein the first direction is opposite to the second direction.

14. The input apparatus of claim 8, wherein the light guiding module comprises:
a light guiding plate;
a reflective layer which is light-proof and set under the light guiding plate; and
a shielding layer, set above the light guiding plate and having a light-proof area and a transparent area;
wherein the plurality of lighting units penetrate the reflective layer and extend into the light guiding plate, the light guiding plate is used for transmitting a light emitted by the plurality of lighting units, the reflective layer is used for reflecting the light, and the shielding layer is used for limiting the light to be emitted out from the transparent area only.

15. An input apparatus, comprising:
a base plate;
at least one keyswitch, set on the base plate;
a light guiding module, set under the base plate; and
a lighting module, set under the light guiding module within the range the base plate covers, the lighting module comprising:
a circuit board; and
a plurality of lighting units, coupled to the circuit board and arranged in a ring form.

16. The input apparatus of claim 15, wherein the plurality of lighting units emits light toward the outside of the ring form.

17. The input apparatus of claim 15, being a lighting keyboard.

18. The input apparatus of claim 15, wherein the circuit board is a soft circuit board.

19. The input apparatus of claim 15, wherein the plurality of lighting units are light emitting diode (LED) devices.

20. The input apparatus of claim 15, wherein the light guiding module comprises:
a light guiding plate;
a reflective layer which is light-proof and set under the light guiding plate; and
a shielding layer, set above the light guiding plate and having a light-proof area and a transparent area;
wherein the plurality of lighting units penetrate the reflective layer and extend into the light guiding plate, the light guiding plate is used for transmitting a light emitted by the plurality of lighting units, the reflective layer is used for reflecting the light, and the shielding layer is used for limiting the light to be emitted out from the transparent area only.
